(19) United States
(12) Patent Application Publication
(10) Pub. No.: US 2005/0076558 A1
(43) Pub. Date: Apr. 14, 2005

(54) Apparatus and method re sinker

(76) Inventor: Lyden Jeffers, Onalaska, WA (US)

Correspondence Address: THOMAS W. SECREST;151 N. MARKET, P.O. Box 1303, Chehalis, WA, 98532, US

(21) Appl. No.: 10/683,235

(22) Filed: Oct. 14, 2003

(51) Int. Cl. A01K 95/00

(52) U.S. Cl. 43/44.87

(57) ABSTRACT

Some fisher persons prefer to make their own sinkers. They use a rod of lead, pliers, and a nail to compress the lead and to place a passageway in the compressed lead to manually make a sinker. This is a slow and time-consuming process and the use of the pliers to compress part of a rod of lead is difficult for some people. The subject matter that is presented is for an apparatus and method for substantially simultaneously squeezing part of a malleable rod to compress part of the rod and to make a compressed rod and to form a passageway in said compressed rod for receiving a leader or a fish line or a spinner.

### CROSS-REFERENCES TO RELATED PATENT APPLICATIONS

There is no related application.

### STATEMENT AS TO RIGHTS TO INVENTIONS MADE UNDER FEDERALLY SPONSORED RESEARCH AND DEVELOPMENT

This invention was developed with private money of the applicant and the applicant has not received federally sponsored research or development.

### REFERENCE TO A “MICROFICHE APPENDIX”

This section is not applicable to this patent application.

### BACKGROUND OF THE INVENTION

1. Field of the Invention

This invention is directed to a sinker or a weight used with a leader or a fishing line and the method of making said sinker or a weight. Some fishermen like to have the fishing hook at a certain depth in the water. In order to achieve this certain depth there is used a weight or a sinker. The weight or sinker must have a higher density and must be heavier than the water so it will sink into the water. A suitable material for a weight or sinker is lead. Lead is malleable, easy to work, and relatively inexpensive. It is possible to make a sinker of a desired weight so that the fishing hook is at the desired depth in the water. Lead is commonly used to make a sinker.

2. Description of the Related Art Including Information Disclosed Under 37 CFR 1.97 and 37 CFR 1.98

Some fishermen make their own sinkers and weights from lead. A roll of lead wire may be purchased. This roll of lead wire may be purchased in a large quantity such as a 500 pound roll. The lead is approximately one-quarter inch in diameter. A lateral cross-section of the lead shows a round wire.

A fisherman will cut off a length of the lead wire to a desired length. The length of lead wire may be one-inch in length or two-inches in length or three-inches in length or longer depending on the desire of the fisherman. Again, the lead is in a one-quarter inch diameter wire. Assume that the fisherman cuts off two inches of the lead wire. Then, the fisherman will take a pair of pliers and flatten one end of the two-inch wire. Maybe the fisherman will take a hammer and pound one end of the two-inch length of wire to have a flat section or a flat end. Then, the fisherman will take a nail and form a passageway in the flat end. The passageway is a hole in the flat end and the fisherman can attach a swivel through this hole or can pass a fishing line through the hole so that the lead now is a sinker or a weight on the fishing line. The fisherman making the sinker or lead weight from this two-inch length of lead wire finds the process time-consuming and hard to produce the product that the fisherman desires.

It is the understanding of the applicant that this is the process used by many fishermen to make a lead weight or a sinker to attach with the leader or fish line. Again, the process is time-consuming and frustrating to a fisherman.

### SUMMARY OF THE INVENTION

A brief description of the subject invention is one where the lead wire, about one-quarter inch in diameter, is fed through clamping and shearing members. The length of the lead wire fed through the clamping and shearing members can be adjusted because of an adjustable stop. There is a bearing member having a cutting edge and a passageway for lead droppings. The bearing member is stationary in position. There is a rotatable knife or shearing member working in conjunction with the bearing member. The rotatable knife has a punch or a pin. The lead wire is positioned on the bearing member. Then, the rotatable knife is rotated toward the lead wire and the bearing member. The rotatable knife compresses the malleable lead wire and, substantially simultaneously, the punch or pin forms a hole or passageway in the compressed lead wire. The rotatable knife in rotating toward the bearing member and the lead wire compresses an end of the lead wire so that the end of the lead wire is substantially flat and at an angle. The punch or pin passes through the flattened end of the lead wire so as to form a hole or passageway and to remove part of the lead wire. The result is a sinker or weight. The hole in the flattened part of the lead weight is used to attach to the leader or a fishing line.

Again, the length of the lead wire can be adjusted for the sinker to a length such as one inch or two inches or three inches or longer.

The rotatable knife is attached to a handle so that an operator can rotate the handle and the knife to form at one end of the lead wire a substantially smooth surface which has been compressed and with a passageway in the end of the compressed lead wire.

The components of this mechanical unit are a fixed bearing surface, a rotatable knife, a guide for the lead wire and a positioning means for wire so that the rotatable knife can compress and flatten one end of the lead wire and, substantially simultaneously, form a hole or passageway in the flattened compressed end of the lead wire.

### BRIEF DESCRIPTION OF THE SEVERAL VIEWS OF THE DRAWING(S)

In the drawings, it is seen that:

FIG. 1 is a top plan view of the apparatus for making a sinker;

FIG. 2 is a bottom plan view of the apparatus;

FIG. 3 is a first side elevational view of the apparatus;

FIG. 4 is a second side elevational view of the apparatus;

FIG. 5 is a first end elevational view of the apparatus;

FIG. 6 is a first side elevational view of the apparatus with the handle in an elevated position and malleable material in position to be worked;

FIG. 7 is a side elevational view of a stationary knife and on its right area there is a knife edge;

FIG. 8, taken on line 8-8, illustrates the stationary knife or anvil, the knife edge, the passageway in the stationary knife and the guide tube in the passageway in the stationary knife;

FIG. 9 is a side elevational view of the moveable knife and illustrates the punch or pin positioned in the moveable knife and also illustrates the cutting edge of the moveable knife;

FIG. 10, taken on line 10-10 of FIG. 9, is looking at the moveable knife and illustrates the recess in the moveable knife and also the punch or pin in the moveable knife for making a passageway in the material to be worked;

FIGS. 11, 12, 13, and 14 are motion figures for the moveable knife with respect to the stationary knife and the material to be worked positioned in the stationary knife or anvil wherein FIG. 11 shows the moveable knife elevated above and away from the material to be worked positioned in the stationary knife or anvil;

FIG. 12 illustrates the moveable knife, the cutting edge of the moveable knife and the punch or pin in the moveable knife positioned next to the material to be worked and which material to be worked is positioned in the stationary knife or anvil;

FIG. 13 illustrates the moveable knife and its cutting edge and the punch or pin in the moveable knife partially cutting through the material to be worked and illustrates the cutting edge on the stationary knife or anvil;

FIG. 14 illustrates the moveable knife as having cut through the material to be worked and having sheared the material to be worked with respect to the sinker;

FIG. 15 is a top plan view of the sinker illustrating the flattened left end or the compressed left end and a passageway in the flattened left end;

FIG. 16 is a bottom plan view of the sinker illustrating the flattened right end or compressed right end with a passageway in the flattened right end;

FIG. 17 is a side-elevational view of the sinker illustrating the flattened left end;

FIG. 18 is an end view looking at the flattened left end or compressed left end of the sinker and illustrates the passageway of the sinker and the round rod in the which the sinker is made;

FIG. 19 is the other end view of the sinker and illustrates the round rod from which the sinker is made and also illustrates, in phantom, the flattened end or compressed end of the sinker;

FIG. 20 is a front elevational view of the combination of the sinker connecting with a swivel which connects with a leader or a line; and

FIG. 21 is a side elevational view of the sinker with a flattened or compressed left end having a passageway in the compressed left end connecting with a swivel which receives a leader or a line.

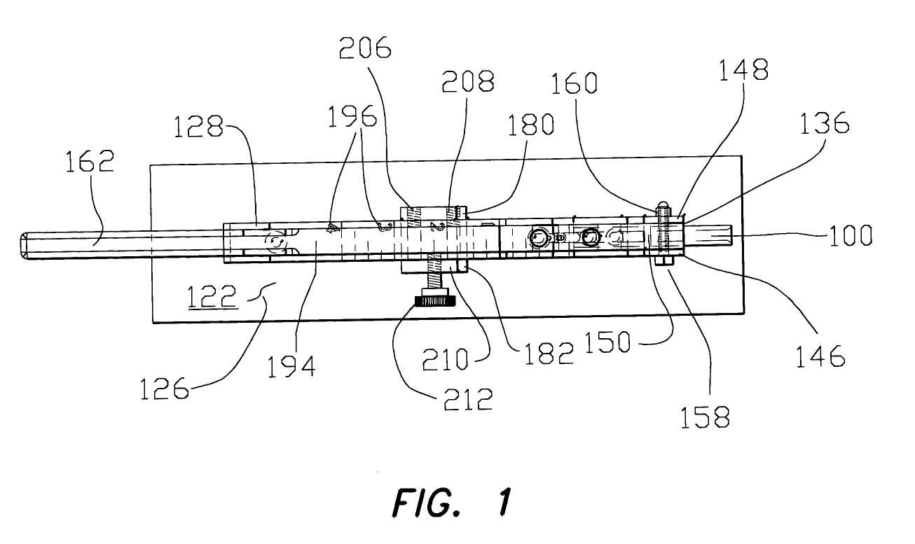

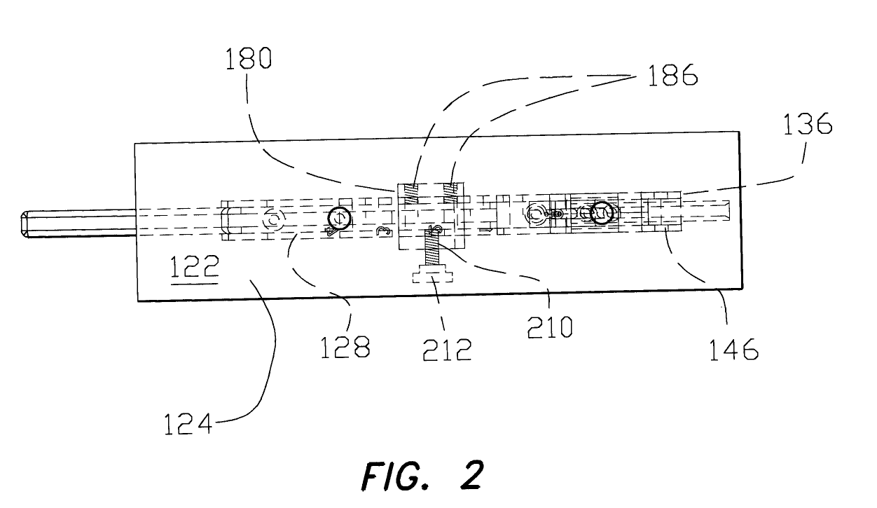

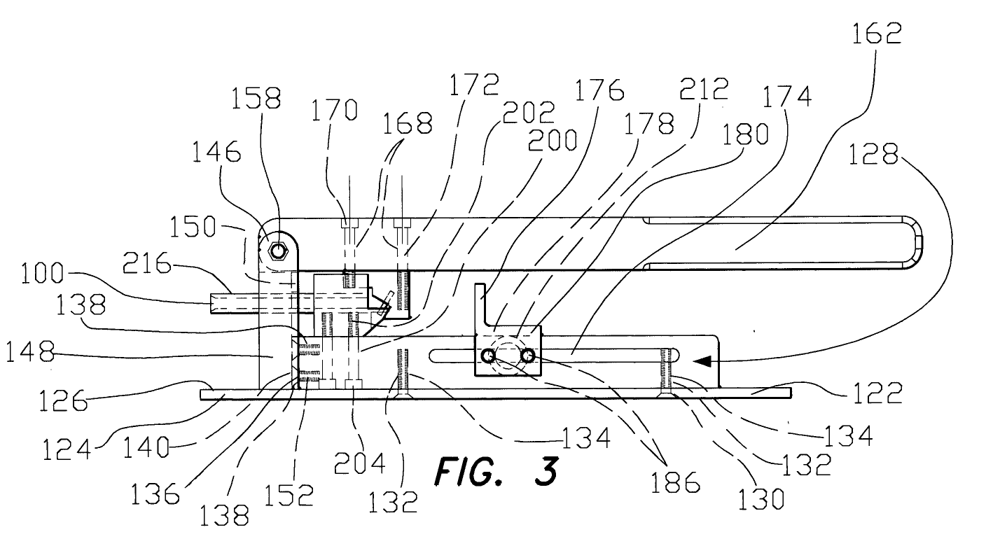

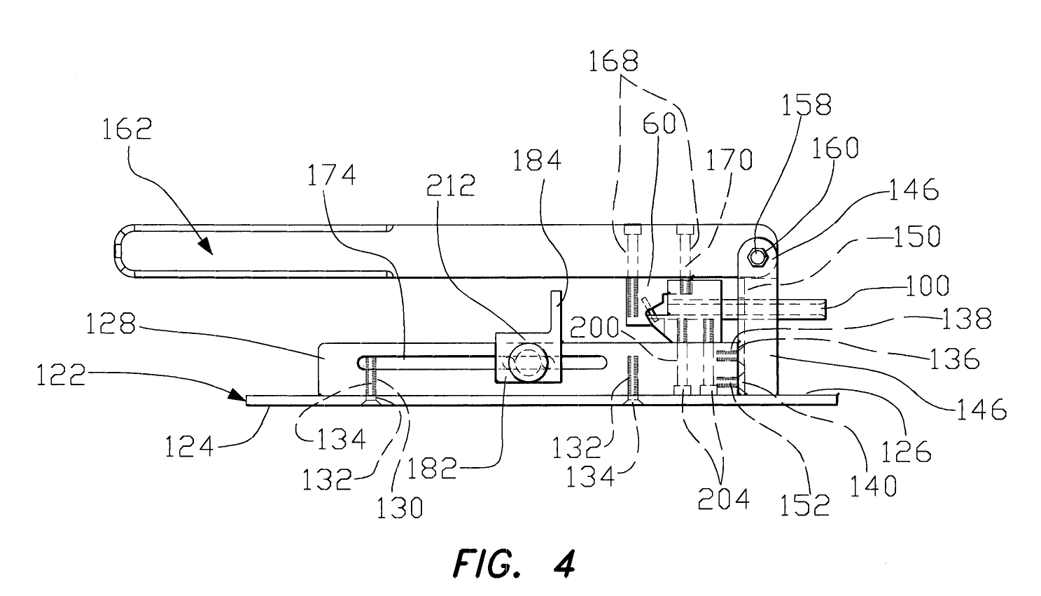

### DETAILED DESCRIPTION OF THE INVENTION

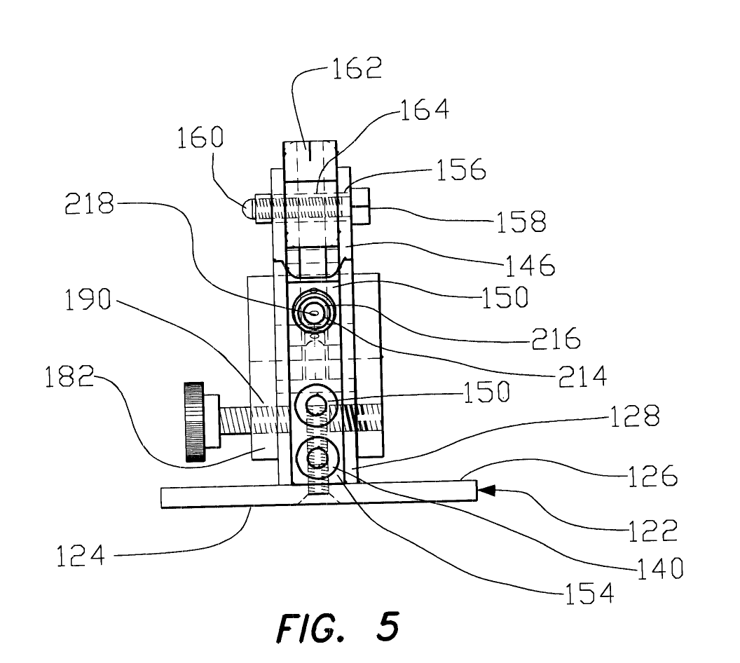

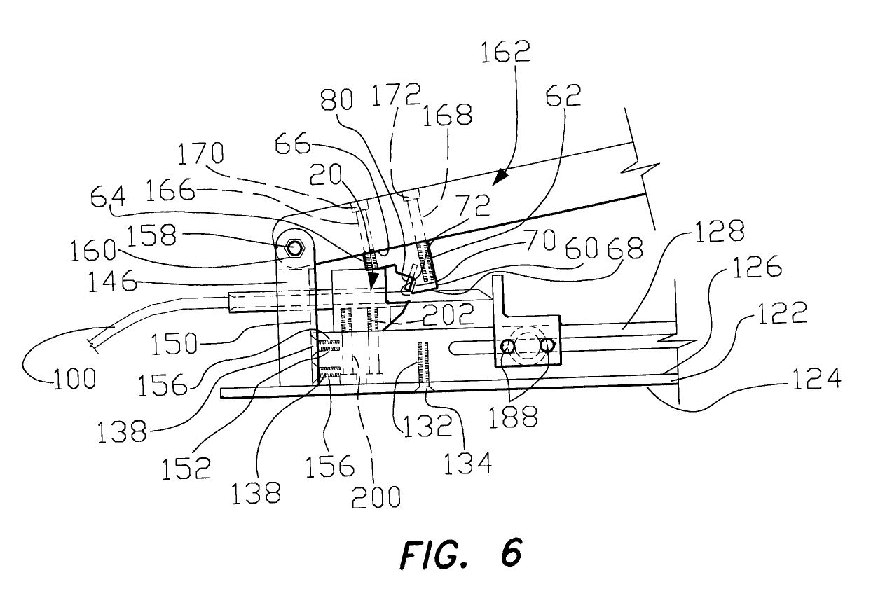

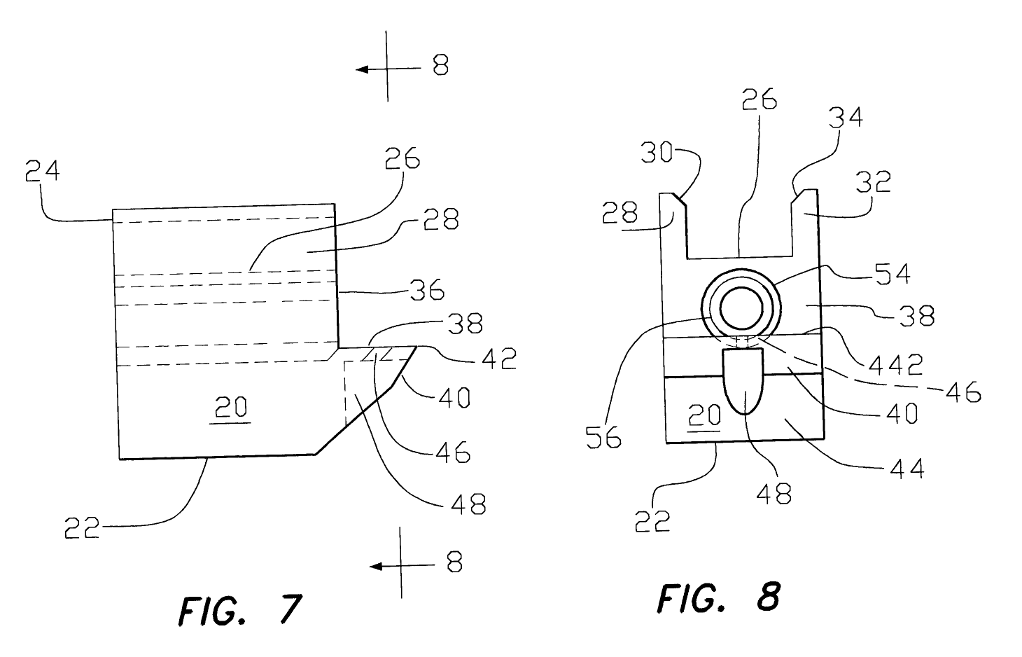

In FIGS. 7 and 8 there is illustrated a stationary knife 20 or an anvil 20. The stationary knife 20 has a lower surface 22 and an entrance side 24. There is a top surface 26 identified in FIG. 8. There is an upright left guide 28 having a left inner bevel 30. There is an upright right guide 32 having an upright bevel 34. There is an exit side 36. There is projected outwardly from the exit side 36 an outwardly projecting ledge 38. From the edge 38 there is a downwardly and inwardly directed surface 40. At the junction of the ledge 38 and the downwardly directed surface 40 there is a knife edge 42 or a shearing edge 42.

In the outwardly projecting ledge 38 there is an angular passageway 46. In the lower part of the ledge 38 there is a recess 48. It is seen that the angular passageway 46 connects with the recess 48. Below the surface 40 there is a downwardly and inwardly projecting surface 44. On the bottom of the knife 20 there is a lower surface 22. In FIG. 8 it is seen that there is an upright left guide 28 having on the inner upper surface a left inner bevel 30. Also, in FIG. 8 it is seen that there is an upright right guide 32 having on its inner surface a bevel 34. Between the guide 28 and the guide 32 there is defined a passageway and the passageway has a surface 26. In the upper part of the knife 20 there is a guide passageway 54 extending from the entrance side 24 to the exit side 36. There may be positioned in the guide passageway 54 housing a guide tube 56. The material to be worked is positioned in the guide tube 56. The guide tube 56 directs and positions the material to be worked. The material to be worked may be a long rod of approximately one-quarter inch diameter. The material to be worked is positioned in the guide tube 56.

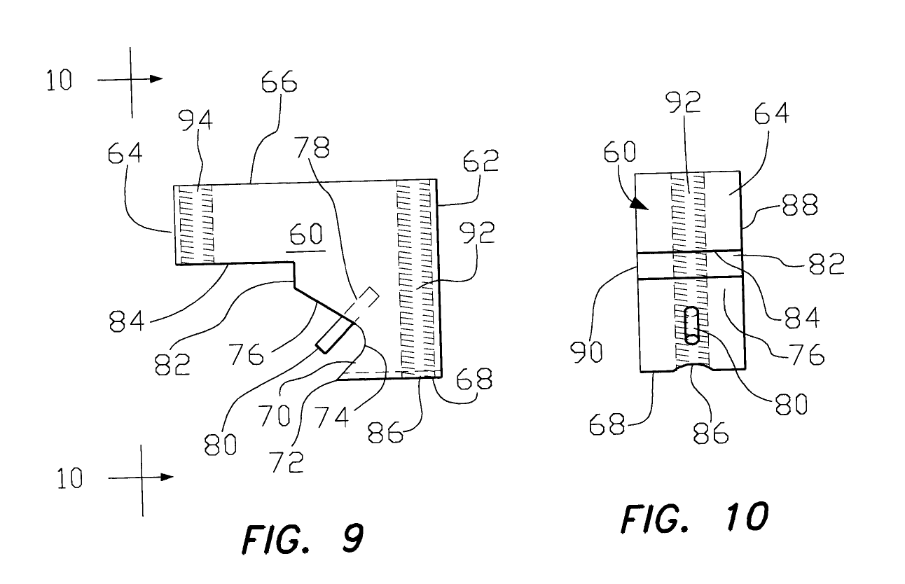

In FIGS. 9 and 10 there is illustrated a moveable knife 60. In FIG. 9 it is seen that the knife 60 has a large right surface 62. Also, in FIG. 9 it is seen that there is a small left surface 64. In FIGS. 9 and 10 the surfaces 62 and 64 are upright or vertical. There is a large upper surface 66 connecting surfaces 62 and 64. On the lower part of the knife 60 there is a short lower surface 68 connecting with the large right surface 62. In FIG. 9 it is seen that there is a recessive surface 70 connecting with the surface 68. The surface 70 curves at 74 and becomes an inclined surface 76. In the inclined surface 76 there is a recess 78. In the recess 78 there is positioned a pin or a punch 80 for forming a passageway in the material to be worked. The inclined surface 76 turns upwardly to form the surface 82. The surface 82 curves at a right angle to form a surface 84 which is parallel to the large right surface 62. In FIG. 10 it is seen that the moveable knife 60 has a right vertical surface 88 and a left vertical surface 90. In the lower surface 68 there is a recess 86 which is illustrated in FIG. 10. In FIG. 9 it is seen that there is a long tapped passageway 92 running from the short lower surface 68 to the long upper surface 66. In FIG. 10 it is seen that there is a short tapped passageway 94 running from the horizontal surface 84 to the long upper surface 66.

FIGS. 11, 12, 13, and 14 illustrate the making of a sinker from a rod of malleable material 100. The rod 100 is positioned in the guide tube 56 in the stationary knife 20. The moveable knife 60 is positioned above the stationary knife 20 and also positioned above the rod 100 in the stationary knife 20. The moveable knife 60 and the punch 80 are positioned above the malleable rod 100.

In FIG. 12 the moveable knife 60 has been moved so that the knife edge 62 is embedded in the rod 100.

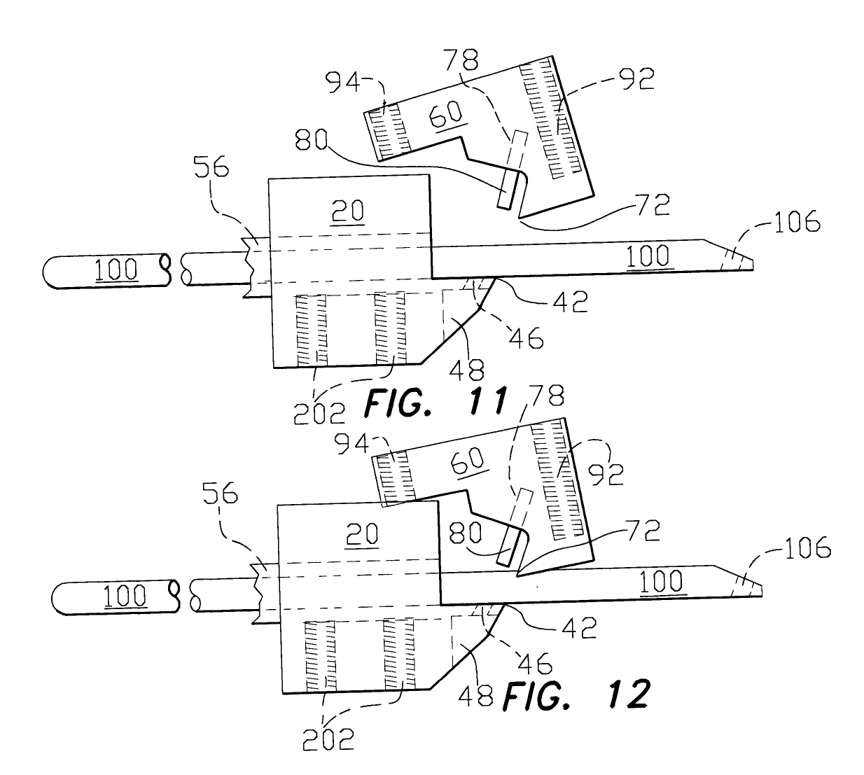

In FIG. 13 the moveable knife 60 has been rotated so that the knife edge 72 has cut through the malleable rod 100 and so that the punch 80 is in the rod 100 but has not completely passed through the rod 100.

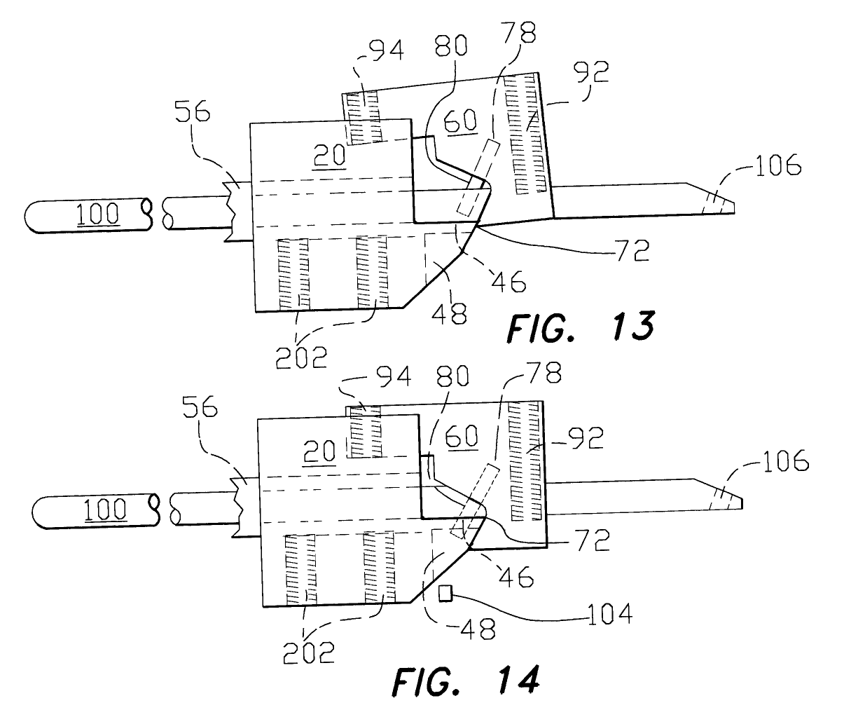

In FIG. 14 the knife edge 72 has passed through the rod 100 and also the punch 80 or pin 80 has passed through the rod 100 to form passageway 106. In FIGS. 11, 12, and 13 there is a rod 100. In FIG. 14 and to the right of the stationary knife 20 there is the sinker 102 having a passageway 106 for attaching to a leader or to a fish line. Also, in FIG. 14 it is seen that there is a little object 104 which is material punched from the rod 100 by the punch 80 or pin 80.

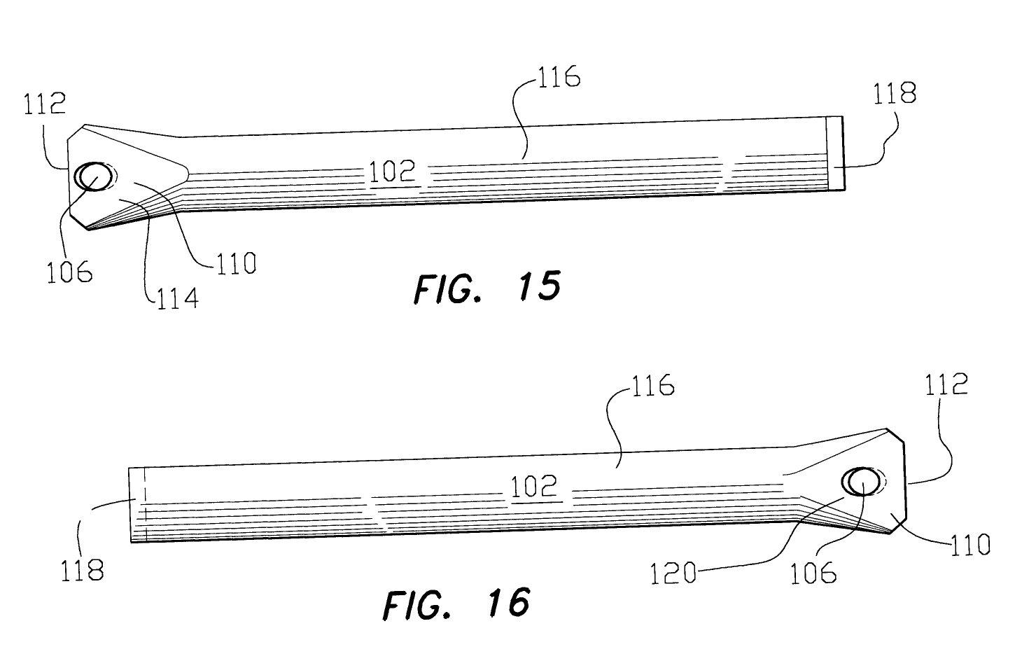

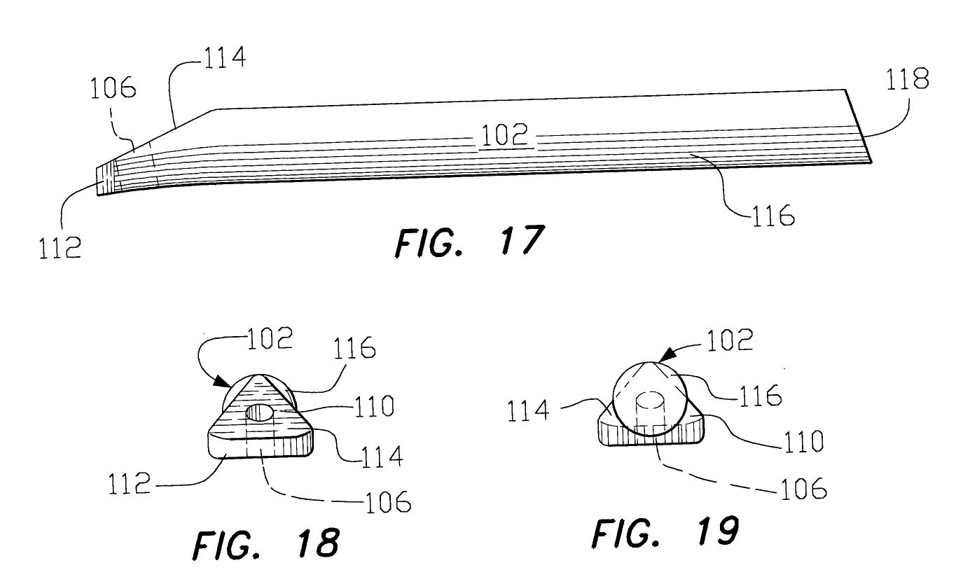

FIGS. 15, 16, 17, 18, and 19 are of the sinker 102. FIG. 15 is a top plan view of the sinker 102. FIG. 16 is a bottom plan view of the sinker 102. FIG. 17 is a side-elevational view of the sinker 102 and it is to be understood that the other side-elevational view is the same. There is a compressed end 110, see FIG. 15, having a hole 106 or passageway 106. The hole 106 or passageway 106 is at an angle with respect to the main body of the sinker 102 and is not at a right angle to the main body of the sinker 102. The upper surface 114 of the compressed end 110 is smooth. The sinker 102 has a body 116. At the compressed end 110 there is an edge 112. At the right end, FIG. 15, the sinker 102 has a slanted end 118.

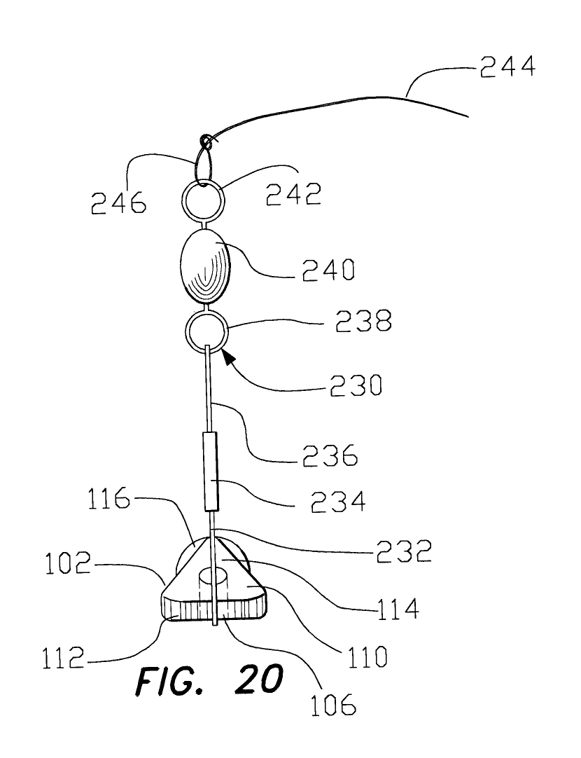

In FIG. 16 it is seen that the compressed end 110 has a smooth lower surface 120. FIG. 17 is a side-elevational of the sinker 102 and shows the compressed end 110 with the smooth upper surface 114. In the compressed end 110 there is the hole or passageway for attaching to a leader or a fish line. It is seen that the hole or passageway is at an angle with respect to the lower surface of the sinker 102. FIG. 18 is an end view looking at the compressed end 110 and the smooth upper surface 114 and also the hole or passageway 106. FIG. 19 is an end view looking at the end of the sinker 102 and there can be seen at the end of the sinker 102 the compressed end 110.

There is supporting structure for the stationary knife 20 and for the moveable knife 60. This supporting structure comprises the rectangular base 122 having a lower flat surface 124 and an upper flat surface 126. There is a support block 128 having a tapped recess 132. A screw 134 is in the tapped recess 132. The support block 128 has a left end 136 and a tapped recess 138 in the left end 136. There is a screw 140 in the tapped recess 138. There is a pivot bracket 146 and an upright standard 148. The pivot bracket and the upright standard are associated with a handle 162. There is a passageway 156 in the upright standard 148. There is a passageway 164 in the handle 162. There is a bolt 158 in the passageways 156 and 164. There is a nut 160 on the bolt 158. The handle 162 rotates around the bolt 158. In the handle 162 there are two spaced-apart passageways 168. These passageways are near the bolt 158. In the passageway 168 near the bolt 158 there is a screw 170 which is screwed into the tapped recess 94 in the moveable knife 60, see FIG. 9. In the passageway 168, away from the bolt 158, there is a bolt 172 which is screwed into the tapped recess 92 in the moveable knife 60. In the base 122 and near the upright standard 148 there are two spaced-apart passageways 200. Also, in the support block 128 near the upright standard 148 are two spaced-apart passageways 200. The passageways 200 in the base 122 and in the support block 128 are aligned. In the fixed knife 20 there are two tapped recesses 202. A screw 204 is positioned in the passageways 200 and screwed into the tapped recesses 202 in the fixed knife 20. This definitely positions the fixed knife 20 with respect to the support block 128 and the base 122. The adjustable stop 176 has a first depending leg 180 and a second depending leg 182. In the first depending leg 180 there are two spaced-apart tapped passageways 206. A screw 208 is positioned in each tapped passageway 206. The purpose of the screw 208 is to align the adjustable stop 176 so that the stop will not rotate around one screw. In the second depending leg 182 there is a tapped passageway 210. By rotating a screw 212 to be in a bearing relation to the support block 212 it is possible to definitely position the adjustable stop 176 with respect to the support block 128 and the indicia 196 in the upper surface of the support block 128. This makes it possible for a person to make variable length sinkers from a coil of malleable material such as lead having a one-quarter inch diameter or a three-sixteenths inch diameter.

In the web 150 there is a passageway 214. Positioned in the passageway 214 is a guide tube 216. Inside of the guide tube 216 there is a malleable rod 218. The guide tube 216 guides the rod 218 and also straightens the rod 218 immediately before the rod 218 is cut to desired length by the stationary knife 20 and the moveable knife 60. The guide tube 216 can be a piece of plastic of a desirable length which is three inches or may be six inches or may be nine inches depending on the desires of the person making the sinker. A three inch guide is satisfactory.

The malleable material 100 can come in a lateral circular configuration having a diameter of one-quarter inch or three-sixteenths inch. The malleable material may have a different lateral cross-sectional configuration but I have used the cross-sectional configuration of a circle. The malleable material 100 may be a long rod or may be in a coil. I have used a twenty-five pound coil of malleable material 100. It is possible to buy a 500 pound coil of malleable material 100. The guide tube 216 straightens the malleable material 100 just prior to forming the sinker 102. The malleable material 100 should have a density greater than the density of water so that the sinker will sink in the water. There are a number of malleable materials having a density greater than the density of water and are easily worked into sinkers. These materials are lead, gold, silver, and copper. From a cost standpoint I have used lead for making a sinker 102.

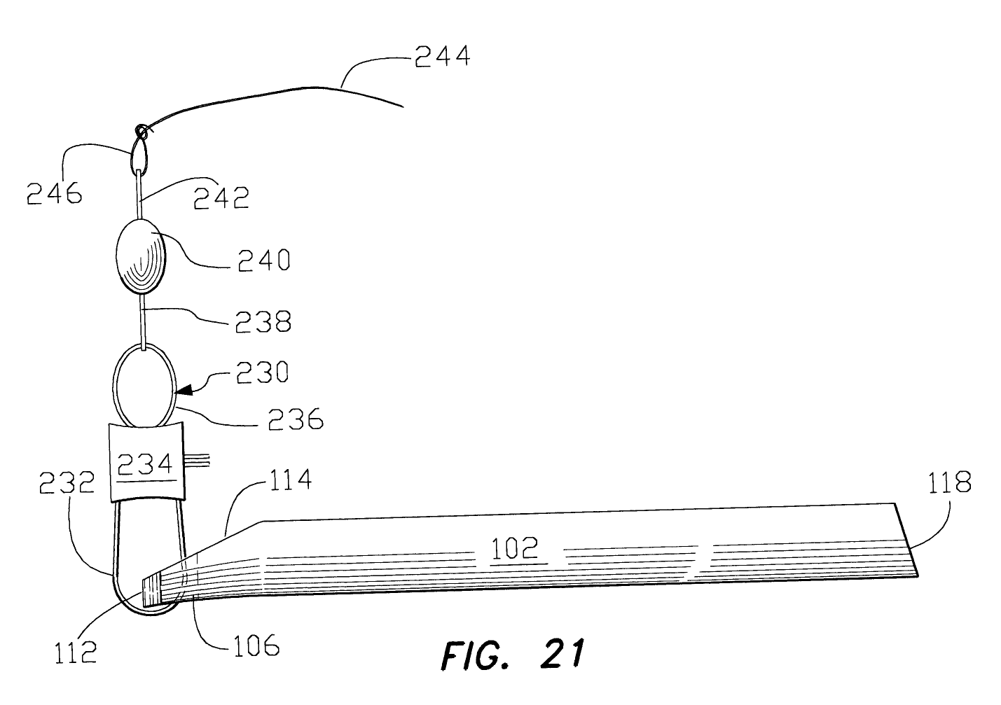

FIGS. 20 and 21 are directed to the combination of the sinker 102 with the swivel 230. In the sinker 102 there is a passageway 106. A lower connector 232 is positioned in the passageway 106. The lower connector 232 connects with the swivel unit 234. The swivel unit 234 makes it possible to disconnect the swivel from the sinker 102. There is an upper connector 236 connecting with the swivel unit 234. In other words the swivel unit 234 also comprises the upper connector 236. A link 238 connects with the upper connector 236. A link 240 connects with the link 238. A link 242 connects with the link 240. A leader 244 connects with the link 242 by means of the loop 246. The leader 244 may connect with the fishing line. The swivel unit 234 makes it possible to disconnect the swivel from the sinker 102 and also to connect the swivel with the sinker 102. Also, the swivel unit 234 makes it possible for the lower connector 232 and the sinker 102 to rotate. The rotation of the sinker 102 makes it possible to be free of tangling of the leader and the fishing line.

An apparatus for simultaneously compressing a material to form a compressed material and to form a passageway in said compressed material and separating said compressed material from the main body of said material and comprising a first shearing means having a first bearing means; a second shearing means having a second bearing means; a third means to move said first shearing means and said second shearing means with respect to each other to compress said material; and a punch associated with one of said shearing means to form a passageway in said compressed material.

An apparatus for simultaneously compressing a material to form a compressed material and to form a passageway in said compressed material and separating said compressed material from the main body of said material and comprising a first shearing means having a first bearing means; a second shearing means having a second bearing means; a third means to move said first shearing means and said second shearing means with respect to each other to compress said material; a punch associated with one of said shearing means to form a passageway in said compressed material; said first shearing means and said second shearing means being positioned to cooperate to sever said material into two pieces.

An apparatus for simultaneously compressing a material to form a compressed material and to form a passageway in said compressed material and separating said compressed material from the main body of said material and comprising a first shearing means having a first bearing means; a second shearing means having a second bearing means; a third means to move said first shearing means and said second shearing means with respect to each other to compress said material; a punch associated with one of said shearing means to form a passageway in said compressed material; and said first shearing means and said second shearing means being positioned to cooperate to sever said material into two pieces while compressing and forming said passageway in said material.

An apparatus for simultaneously compressing a material to form a compressed material and to form a passageway in said compressed material and separating said compressed material from the main body of said material and comprising a first shearing means having a first bearing means; a second shearing means having a second bearing means; a third means to move said first shearing means and said second shearing means with respect to each other to compress said material; a punch associated with one of said shearing means to form a passageway in said compressed material; said first shearing means and said second said second shearing means being positioned to cooperate to sever said material into two pieces while compressing and forming said passageway in said material; and a guide for guiding said material to said first shearing means and to said second shearing means.

An apparatus for simultaneously compressing a material to form a compressed material and to form a passageway in said compressed material and separating said compressed material from the main body of said material and comprising a first shearing means having a first bearing means; a second shearing means having a second bearing means; a third means to move said first shearing means and said second shearing means with respect to each other to compress said material; a punch associated with one of said shearing means to form a passageway in said compressed material; said first shearing means and said second said second shearing means being positioned to cooperate to sever said material into two pieces while compressing and forming said passageway in said material; a support base for said first shearing means; a moveable handle; and said second shearing means being mounted on said handle in an operative position with respect to said first shearing means.

An apparatus for simultaneously compressing a material to form a compressed material and to form a passageway in said compressed material and separating said compressed material from the main body of said material and comprising a first shearing means having a first bearing means; a second shearing means having a second bearing means; a third means to move said first shearing means and said second shearing means with respect to each other to compress said material; a punch associated with one of said shearing means to form a passageway in said compressed material; said first shearing means and said second said second shearing means being positioned to cooperate to sever said material into two pieces while compressing and forming said passageway in said material; and an indicia associated with said first shearing means and with said second shearing means for measuring said material.

An apparatus for simultaneously compressing a material to form a compressed material and to form a passageway in said compressed material and separating said compressed material from the main body of said material and comprising a first shearing means having a first bearing means; a second shearing means having a second bearing means; a third means to move said first shearing means and said second shearing means with respect to each other to compress said material; a punch associated with one of said shearing means to form a passageway in said compressed material; a support base; an upright standard operatively connecting with said support base; an axle operatively connecting with said upright standard; and a handle positioned on said axle for rotational purposes for moving said first shearing means with respect to said second shearing means.

An apparatus for simultaneously compressing a material to form a compressed material and to form a passageway in said compressed material and separating said compressed material from the main body of said material and comprising a first shearing means having a first bearing means; a second shearing means having a second bearing means; a third means to move said first shearing means and said second shearing means with respect to each other to compress said material; a punch associated with one of said shearing means to form a passageway in said compressed material; a support base; an upright standard operatively connecting with said support base; an axle operatively connecting with said upright standard; a handle positioned on said axle for rotational purposes for moving said first shearing means with respect to said second shearing means; a guide base on said support base; said first shearing means positioned on said guide base; said first shearing means having an outwardly projecting ledge having a first knife edge; and said second shearing means mounted on said moveable handle and said second shearing means having a second knife edge.

An apparatus for simultaneously compressing a material to form a compressed material and to form a passageway in said compressed material and separating said compressed material from the main body of said material and comprising a first shearing means having a first bearing means; a second shearing means having a second bearing means; a third means to move said first shearing means and said second shearing means with respect to each other to compress said material; a punch associated with one of said shearing means to form a passageway in said compressed material; a support base; an upright standard operatively connecting with said support base; an axle operatively connecting with said upright standard; a handle positioned on said axle for rotational purposes for moving said first shearing means with respect to said second shearing means; a guide base on said support base; said first shearing means positioned on said guide base; said first shearing means having an outwardly projecting ledge having a first knife edge; said second shearing means mounted on said moveable handle and said second shearing means having a second knife edge; said second shearing means having said punch; and said first shearing means having a passageway in said outwardly projecting ledge for receiving discarded material from said material and also for receiving said punch.

An apparatus for simultaneously compressing a material to form a compressed material and to form a passageway in said compressed material and separating said compressed material from the main body of said material and comprising a first shearing means having a first bearing means; a second shearing means having a second bearing means; a third means to move said first shearing means and said second shearing means with respect to each other to compress said material; a punch associated with one of said shearing means to form a passageway in said compressed material; a support base; an upright standard operatively connecting with said support base; an axle operatively connecting with said upright standard; a handle positioned on said axle for rotational purposes for moving said first shearing means with respect to said second shearing means; a guide base on said support base; said first shearing means positioned on said guide base; said first shearing means having an outwardly projecting ledge having a first knife edge; said second shearing means mounted on said moveable handle and said second shearing means having a second knife edge; said second shearing means having said punch; said first shearing means having a passageway in said outwardly projecting ledge for receiving discarded material from said material and also for receiving said punch; indicia on said guide base for measuring said material; and a moveable stop mounted on said guide base to assist in measuring said material.

A process for making an apparatus which simultaneously compresses a material to form a compressed material and simultaneously to form a passageway in said compressed material and simultaneously to sever said compressed material from the main body of said material, and said process comprising forming a first shearing means having a first bearing means; forming a second shearing means having a second bearing means; forming a third means to move said first shearing means and said second shearing means with respect to each other to compress said material; and associating a punch with one of said shearing means to form a passageway in said compressed material.

A process for making an apparatus which simultaneously compresses a material to form a compressed material and simultaneously to form a passageway in said compressed material and simultaneously to sever said compressed material from the main body of said material, and said process comprising forming a first shearing means having a first bearing means; forming a second shearing means having a second bearing means; forming a third means to move said first shearing means and said second shearing means with respect to each other to compress said material; associating a punch with one of said shearing means to form a passageway in said compressed material; and positioning said first shearing means and said second shearing means to cooperate with each other to sever said material into two pieces.

A process for making an apparatus which simultaneously compresses a material to form a compressed material and simultaneously to form a passageway in said compressed material and simultaneously to sever said compressed material from the main body of said material, and said process comprising forming a first shearing means having a first bearing means; forming a second shearing means having a second bearing means; forming a third means to move said first shearing means and said second shearing means with respect to each other to compress said material; associating a punch with one of said shearing means to form a passageway in said compressed material; and positioning said first shearing means and said second shearing means to cooperate with each other to sever said material into two pieces while compressing and forming said passageway in said material.

A process for making an apparatus which simultaneously compresses a material to form a compressed material and simultaneously to form a passageway in said compressed material and simultaneously to sever said compressed material from the main body of said material, and said process comprising forming a first shearing means having a first bearing means; forming a second shearing means having a second bearing means; forming a third means to move said first shearing means and said second shearing means with respect to each other to compress said material; associating a punch with one of said shearing means to form a passageway in said compressed material; positioning said first shearing means and said second shearing means to cooperate with each other to sever said material into two pieces while compressing and forming said passageway in said material; and employing a guide for guiding said material to said first shearing means and to said second shearing means.

An apparatus for simultaneously compressing a material to form a compressed material and to form a passageway in said compressed material and separating said compressed material from the main body of said material and comprising a first shearing means having a first bearing means; a second shearing means having a second bearing means; a third means to move said first shearing means and said second shearing means with respect to each other to compress said material; a punch associated with one of said shearing means to form a passageway in said compressed material; said first shearing means and said second said second shearing means being positioned to cooperate to sever said material into two pieces while compressing and forming said passageway in said material; a support base for said first shearing means; a moveable handle; said second shearing means being mounted on said handle in an operative position with respect to said first shearing means; employing a guide for guiding said material to said first shearing means and said second shearing means; employing a moveable handle; and mounting said second shearing means on said moveable handle in an operative position with respect to said first shearing means.

A process for making an apparatus which simultaneously compresses a material to form a compressed material and simultaneously to form a passageway in said compressed material and simultaneously to sever said compressed material from the main body of said material, and said process comprising forming a first shearing means having a first bearing means; forming a second shearing means having a second bearing means; forming a third means to move said first shearing means and said second shearing means with respect to each other to compress said material; associating a punch with one of said shearing means to form a passageway in said compressed material; positioning said first shearing means and said second shearing means to cooperate with each other to sever said material into two pieces while compressing and forming said passageway in said material; and associating indicia with said first shearing means and with said second shearing means for measuring said material.

A process for making an apparatus which simultaneously compresses a material to form a compressed material and simultaneously to form a passageway in said compressed material and simultaneously to sever said compressed material from the main body of said material, and said process comprising forming a first shearing means having a first bearing means; forming a second shearing means having a second bearing means; forming a third means to move said first shearing means and said second shearing means with respect to each other to compress said material; associating a punch with one of said shearing means to form a passageway in said compressed material; providing a support base; operatively connecting an upright standard with said support base; operatively connecting an axle with said upright standard; and positioning a handle on said axle for rotational purposes for moving said first shearing means with respect to said second shearing means.

A process for making an apparatus which simultaneously compresses a material to form a compressed material and simultaneously to form a passageway in said compressed material and simultaneously to sever said compressed material from the main body of said material, and said process comprising forming a first shearing means having a first bearing means; forming a second shearing means having a second bearing means; forming a third means to move said first shearing means and said second shearing means with respect to each other to compress said material; associating a punch with one of said shearing means to form a passageway in said compressed material; providing a support base; operatively connecting an upright standard with said support base; operatively connecting an axle with said upright standard; positioning a handle on said axle for rotational purposes for moving said first shearing means with respect to said second shearing means; mounting a guide base on said support base; positioning said first shearing means on said guide base; forming said first shearing means to have an outwardly projecting ledge having a first knife edge; forming said second means to have a second knife edge; and mounting said second shearing means on said moveable handle.

A process for making an apparatus which simultaneously compresses a material to form a compressed material and simultaneously to form a passageway in said compressed material and simultaneously to sever said compressed material from the main body of said material, and said process comprising forming a first shearing means having a first bearing means; forming a second shearing means having a second bearing means; forming a third means to move said first shearing means and said second shearing means with respect to each other to compress said material; associating a punch with one of said shearing means to form a passageway in said compressed material; providing a support base; operatively connecting an upright standard with said support base; operatively connecting an axle with said upright standard; positioning a handle on said axle for rotational purposes for moving said first shearing means with respect to said second shearing means; mounting a guide base on said support base; positioning said first shearing means on said guide base; forming said first shearing means to have an outwardly projecting ledge having a first knife edge; forming said second means to have a second knife edge; mounting said second shearing means on said moveable handle; mounting said punch on said second shearing means; and forming a passageway in said outwardly projecting ledge in said first shearing means for receiving discarded material from said material and also for receiving said punch.

A process for making an apparatus which simultaneously compresses a material to form a compressed material and simultaneously to form a passageway in said compressed material and simultaneously to sever said compressed material from the main body of said material, and said process comprising forming a first shearing means having a first bearing means; forming a second shearing means having a second bearing means; forming a third means to move said first shearing means and said second shearing means with respect to each other to compress said material; associating a punch with one of said shearing means to form a passageway in said compressed material; providing a support base; operatively connecting an upright standard with said support base; operatively connecting an axle with said upright standard; positioning a handle on said axle for rotational purposes for moving said first shearing means with respect to said second shearing means; mounting a guide base on said support base; positioning said first shearing means on said guide base; forming said first shearing means to have an outwardly projecting ledge having a first knife edge; forming said second means to have a second knife edge; mounting said second shearing means on said moveable handle; mounting said punch on said second shearing means; forming a passageway in said outwardly projecting ledge in said first shearing means for receiving discarded material from said material and also for receiving said punch; providing indicia on said guide base for measuring said material; and providing a moveable stop mounted on said guide base to assist in measuring said material.

An apparatus which simultaneously compresses a material to form a compressed material and simultaneously to form a passageway in said compressed material and simultaneously to sever said compressed material from the main body of said material, and made by a process comprising forming a first shearing means having a first bearing means; forming a second shearing means having a second bearing means; forming a third means to move said first shearing means and said second shearing means with respect to each other to compress said material; and associating a punch with one of said shearing means to form a passageway in said compressed material.

An apparatus which simultaneously compresses a material to form a compressed material and simultaneously to form a passageway in said compressed material and simultaneously to sever said compressed material from the main body of said material, and made by a process comprising forming a first shearing means having a first bearing means; forming a second shearing means having a second bearing means; forming a third means to move said first shearing means and said second shearing means with respect to each other to compress said material; associating a punch with one of said shearing means to form a passageway in said compressed material; and positioning said first shearing means and said second shearing means to cooperate with each other to sever said material into two pieces.

An apparatus which simultaneously compresses a material to form a compressed material and simultaneously to form a passageway in said compressed material and simultaneously to sever said compressed material from the main body of said material, and made by a process comprising forming a first shearing means having a first bearing means; forming a second shearing means having a second bearing means; forming a third means to move said first shearing means and said second shearing means with respect to each other to compress said material; associating a punch with one of said shearing means to form a passageway in said compressed material; and positioning said first shearing means and said second shearing means to cooperate with each other to sever said material into two pieces while simultaneously compressing and simultaneously forming said passageway in said material.

An apparatus which simultaneously compresses a material to form a compressed material and simultaneously to form a passageway in said compressed material and simultaneously to sever said compressed material from the main body of said material, and made by a process comprising forming a first shearing means having a first bearing means; forming a second shearing means having a second bearing means; forming a third means to move said first shearing means and said second shearing means with respect to each other to compress said material; associating a punch with one of said shearing means to form a passageway in said compressed material; positioning said first shearing means and said second shearing means to cooperate with each other to sever said material into two pieces while simultaneously compressing and simultaneously forming said passageway in said material; and employing a guide for guiding said material to said first shearing means and to said second shearing means.

An apparatus which simultaneously compresses a material to form a compressed material and simultaneously to form a passageway in said compressed material and simultaneously to sever said compressed material from the main body of said material, and made by a process comprising forming a first shearing means having a first bearing means; forming a second shearing means having a second bearing means; forming a third means to move said first shearing means and said second shearing means with respect to each other to compress said material; associating a punch with one of said shearing means to form a passageway in said compressed material; positioning said first shearing means and said second shearing means to cooperate with each other to sever said material into two pieces while simultaneously compressing and simultaneously forming said passageway in said material; employing a guide for guiding said material to said first shearing means and to said second shearing means; employing a moveable handle; and mounting said second shearing means on said moveable handle in an operative position with respect to said first shearing means.

An apparatus which simultaneously compresses a material to form a compressed material and simultaneously to form a passageway in said compressed material and simultaneously to sever said compressed material from the main body of said material, and made by a process comprising forming a first shearing means having a first bearing means; forming a second shearing means having a second bearing means; forming a third means to move said first shearing means and said second shearing means with respect to each other to compress said material; associating a punch with one of said shearing means to form a passageway in said compressed material; positioning said first shearing means and said second shearing means to cooperate with each other to sever said material into two pieces while simultaneously compressing and simultaneously forming said passageway in said material; and associating indicia with said first shearing means and with said second shearing means for measuring said material.

An apparatus which simultaneously compresses a material to form a compressed material and simultaneously to form a passageway in said compressed material and simultaneously to sever said compressed material from the main body of said material, and made by a process comprising forming a first shearing means having a first bearing means; forming a second shearing means having a second bearing means; forming a third means to move said first shearing means and said second shearing means with respect to each other to compress said material; associating a punch with one of said shearing means to form a passageway in said compressed material; providing a support base; operatively connecting an upright standard with said support base; operatively connecting an axle with said upright standard; and positioning a handle on said axle for rotational purposes for moving said first shearing means with respect to said second shearing means.

A process for making an apparatus which simultaneously compresses a material to form a compressed material and simultaneously to form a passageway in said compressed material and simultaneously to sever said compressed material from the main body of said material, and said process comprising forming a first shearing means having a first bearing means; forming a second shearing means having a second bearing means; forming a third means to move said first shearing means and said second shearing means with respect to each other to compress said material; associating a punch with one of said shearing means to form a passageway in said compressed material; providing a support base; operatively connecting an upright standard with said support base; operatively connecting an axle with said upright standard; positioning a handle on said axle for rotational purposes for moving said first shearing means with respect to said second shearing means; mounting a guide base on said support base; positioning said first shearing means on said guide base; forming said first shearing means to have an outwardly projecting ledge having a first knife edge; forming said second means to have a second knife edge; and mounting said second shearing means on said moveable handle.

A process for making an apparatus which simultaneously compresses a material to form a compressed material and simultaneously to form a passageway in said compressed material and simultaneously to sever said compressed material from the main body of said material, and said process comprising forming a first shearing means having a first bearing means; forming a second shearing means having a second bearing means; forming a third means to move said first shearing means and said second shearing means with respect to each other to compress said material; associating a punch with one of said shearing means to form a passageway in said compressed material; providing a support base; operatively connecting an upright standard with said support base; operatively connecting an axle with said upright standard; positioning a handle on said axle for rotational purposes for moving said first shearing means with respect to said second shearing means; mounting a guide base on said support base; positioning said first shearing means on said guide base; forming said first shearing means to have an outwardly projecting ledge having a first knife edge; forming said second means to have a second knife edge; mounting said second shearing means on said moveable handle; mounting said punch on said second shearing means; and forming a passageway in said outwardly projecting ledge in said first shearing means for receiving discarded material from said material and also for receiving said punch.

A process for making an apparatus which simultaneously compresses a material to form a compressed material and simultaneously to form a passageway in said compressed material and simultaneously to sever said compressed material from the main body of said material, and said process comprising forming a first shearing means having a first bearing means; forming a second shearing means having a second bearing means; forming a third means to move said first shearing means and said second shearing means with respect to each other to compress said material; associating a punch with one of said shearing means to form a passageway in said compressed material; providing a support base; operatively connecting an upright standard with said support base; operatively connecting an axle with said upright standard; positioning a handle on said axle for rotational purposes for moving said first shearing means with respect to said second shearing means; mounting a guide base on said support base; positioning said first shearing means on said guide base; forming said first shearing means to have an outwardly projecting ledge having a first knife edge; forming said second means to have a second knife edge; mounting said second shearing means on said moveable handle; mounting said punch on said second shearing means; forming a passageway in said outwardly projecting ledge in said first shearing means for receiving discarded material from said material and also for receiving said punch; providing indicia on said guide base for measuring said material; and providing a moveable stop mounted on said guide base to assist in measuring said material.

A combination of a sinker and a swivel and comprising said sinker having a sloping first end of varying thickness with the end of said first end being relatively thin as compared to the main body of said sinker; a passageway in said sloping first end; and a swivel in said passageway.

A process for making a combination of a sinker and a swivel, said process comprising processing a malleable material to have a sloping first end of varying thickness with the end of said sloping first end being relatively thin as compared to the main body of said material; forming a passageway in said sloping first end; and positioning a swivel in said passageway.

A combination of a sinker and a swivel made by a process comprising processing a malleable material to have a sloping first end of varying thickness with the end of said sloping first end being relatively thin as compared to the main body of said sinker; forming a passageway in said sloping first end; positioning a swivel in said passageway.

1. An apparatus for simultaneously compressing a material to form a compressed material and to form a passageway in said compressed material and separating said compressed material from the main body of said material and comprising:
a. a first shearing means having a first bearing means;
b. a second shearing means having a second bearing means;
c. a third means to move said first shearing means and said second shearing means with respect to each other to compress said material; and
d. a punch associated with one of said shearing means to form a passageway in said compressed material.

2. An apparatus according to claim 1 and comprising:
a. said first shearing means and said second shearing means being positioned to cooperate to sever said material into two pieces while compressing and forming said passageway in said material.

3. An apparatus according to claim 2 and comprising:
a. a guide for guiding said material to said first shearing means and to said second shearing means.

4. An apparatus according to claim 1 and comprising:
a. a support base;
b. an upright standard operatively connecting with said support base;
c. an axle operatively connecting with said upright standard; and
d. a handle positioned on said axle for rotational purposes for moving said first shearing means with respect to said second shearing means.

5. An apparatus according to claim 4 and comprising:
a. a guide base on said support base;
b. said first shearing means positioned on said guide base;
c. said first shearing means having an outwardly projecting ledge having a first knife edge; and
d. said second shearing means mounted on said moveable handle and said second shearing means having a second knife edge.

6. An apparatus according to claim 5 and comprising:
a. said second shearing means having said punch;
b. said first shearing means having a passageway in said outwardly projecting ledge for receiving discarded material from said material and also for receiving said punch.

7. A process for making an apparatus which simultaneously compresses a material to form a compressed material and simultaneously to form a passageway in said compressed material and simultaneously to sever said compressed material from the main body of said material, and said process comprising:
a. forming a first shearing means having a first bearing means;
b. forming a second shearing means having a second bearing means;
c. forming a third means to move said first shearing means and said second shearing means with respect to each other to compress said material; and
d. associating a punch with one of said shearing means to form a passageway in said compressed material.

8. A process for making an apparatus according to claim 7 and comprising:
a. positioning said first shearing means and said second shearing means to cooperate with each other to sever said material into two pieces while compressing and forming said passageway in said material.

9. A process for making an apparatus according to claim 8 and comprising:
a. employing a guide for guiding said material to said first shearing means and to said second shearing means.

10. A process for making an apparatus according to claim 7 and comprising:
a. providing a support base;
b. operatively connecting an upright standard with said support base;
c. operatively connecting an axle with said upright standard; and
d. positioning a handle on said axle for rotational purposes for moving said first shearing means with respect to said second shearing means.

11. A process for making an apparatus according to claim 10 and comprising:
a. mounting a guide base on said support base;
b. positioning said first shearing means on said guide base;
c. forming said first shearing means to have an outwardly projecting ledge having a first knife edge;
d. forming said second means to have a second knife edge; and
e. mounting said second shearing means on said moveable handle.

12. A process for making an apparatus according to claim 11 and comprising:
a. mounting said punch on said second shearing means; and
b. forming a passageway in said outwardly projecting ledge in said first shearing means for receiving discarded material from said material and also for receiving said punch.

13. An apparatus which simultaneously compresses a material to form a compressed material and simultaneously to form a passageway in said compressed material and simultaneously to sever said compressed material from the main body of said material, and made by a process comprising:
a. forming a first shearing means having a first bearing means;
b. forming a second shearing means having a second bearing means;
c. forming a third means to move said first shearing means and said second shearing means with respect to each other to compress said material; and
d. associating a punch with one of said shearing means to form a passageway in said compressed material.

14. An apparatus made by a process according to claim 13 and comprising:
a. positioning said first shearing means and said second shearing means to cooperate with each other to sever said material into two pieces while simultaneously compressing and simultaneously forming said passageway in said material.

15. An apparatus made by a process according to claim 23 and comprising:
a. employing a guide for guiding said material to said first shearing means and to said second shearing means.

16. An apparatus made by a process according to claim 13 and comprising:
a. providing a support base;
b. operatively connecting an upright standard with said support base;
c. operatively connecting an axle with said upright standard; and
d. positioning a handle on said axle for rotational purposes for moving said first shearing means with respect to said second shearing means.

17. An apparatus made by a process according to claim 10 and comprising:
a. mounting a guide base on said support base;
b. positioning said first shearing means on said guide base;
c. forming said first shearing means to have an outwardly projecting ledge having a first knife edge;
d. forming said second means to have a second knife edge; and
e. mounting said second shearing means on said moveable handle.

18. A combination of a sinker and a swivel and comprising:
a. said sinker having a sloping first end of varying thickness with the end of said first end being relatively thin as compared to the main body of said sinker;
b. a passageway in said sloping first end; and
c. a swivel in said passageway.

19. A process for making a combination of a sinker and a swivel, said process comprising:
a. processing a malleable material to have a sloping first end of varying thickness with the end of said sloping first end being relatively thin as compared to the main body of said material;
b. forming a passageway in said sloping first end; and
c. positioning a swivel in said passageway.

20. A combination of a sinker and a swivel made by a process comprising:
a. processing a malleable material to have a sloping first end of varying thickness with the end of said sloping first end being relatively thin as compared to the main body of said sinker;
b. forming a passageway in said sloping first end;
c. positioning a swivel in said passageway.
